(19) United States
(12) Patent Application Publication
(10) Pub. No.: US 2015/0264715 A1
(43) Pub. Date: Sep. 17, 2015

(54) WIRELESS COMMUNICATIONS TERMINAL, WIRELESS COMMUNICATIONS SYSTEM AND METHOD THEREOF

(71) Applicant: SAMSUNG ELECTRO-MECHANICS CO., LTD., Suwon-Si (KR)

(72) Inventors: Sung Ho HWANG, Suwon-Si (KR); Yong Woon PARK, Suwon-Si (KR)

(21) Appl. No.: 14/340,458

(22) Filed: Jul. 24, 2014

(30) Foreign Application Priority Data
Mar. 12, 2014 (KR) 10-2014-0028818

(51) Int. Cl. H04W 74/08; H04W 16/14

(52) U.S. Cl. CPC H04W 74/0816; H04W 16/14

(57) ABSTRACT

A wireless communication method may include receiving channel frequency information, detecting an unused channel not currently in use through reference to the channel frequency information, transmitting a request to send (RTS) signal including a frequency number and duration of the unused channel when the unused channel is detected, receiving a clear to send signal corresponding to the request to send signal and performing wireless communications using the unused channel.

### CROSS-REFERENCE TO RELATED APPLICATION

This application claims the benefit of Korean Patent Application No. 10-2014-0028818 filed on Mar. 12, 2014, with the Korean Intellectual Property Office, the disclosure of incorporated herein by reference.

### BACKGROUND

The present disclosure relates to a wireless communications terminal, a wireless communications system, and a method thereof.

Recently, in the field of wireless communications, in accordance with increasing interest in wireless communications using TV white space (TVWS) bands and the development of technology related thereto, research thereinto has been actively conducted.

In general, TV white spaces (TVWS) are vacant frequency bands not used by broadcasters in very high frequency (VHF) and ultra high frequency (UHF) bands, commonly distributed adjacently to bandwidths used for TV broadcasting, commonly being referred to as non-licensed bands that may be used by anyone, once government radio frequency band allocation regulations are satisfied.

Specifically, in terms of TVWS, the term spatially refers to broadcast bands left vacant for fear of frequency interference between broadcast signals and frequency bands that are not used in respective regions not used for broadcasting radio waves, while the term temporally refers to vacant broadcasting frequencies at times in which broadcasters do not transmit broadcast signals during certain times of the day.

Communications using TV white spaces should not disturb TV reception by causing interference with TV broadcasts for TV viewers who are customers of the broadcaster and should also not have influence on wireless audio signals that use a portion of the bands to communicate at a small output.

In order to satisfy the above-mentioned conditions, TV white space devices require technologies such as 1) a spectrum sensing technology sensing TV channels in use to protect established broadcast channels, 2) a database and access protocol technology having location-based TV channel information, 3) mutual coexistence technology for heterogeneous devices using the TVWS band, 4) an intelligent and autonomous wireless connection factor technology for variable wireless channels, 5) a subscriber authentication system for protecting wireless channels as well as security technology for protecting databases and users, and the like.

Particularly, mutual coexistence technology between heterogeneous devices using the TVWS band and the intelligent and autonomous wireless connection factor technology for the variable wireless channels are problematic technologies, in that the communications using TV white spaces are performed in a plurality of frequency channels in which the broadcasting frequency bands (54-852 MHz) are divided into 6/7/8M, or the like.

Specifically, collision preventing technology has been urgently demanded to allow for increased connection efficiency by preventing collisions between broadcast data from additional terminals in a multi-frequency environment and also demanded to be suitable for a multi frequency environment in a case in which a reconnection occurs due to the occurrence of a collision or broadcasting traffic (an incumbent user (IU), for example, a broadcast signal, a microphone signal, or the like).

### SUMMARY

An exemplary embodiment in the present disclosure may provide a wireless communications system capable of preventing data collisions by allowing a terminal to output a request to send (RTS) signal including a frequency number and duration to thereby cause another terminal to select and access another frequency channel, and a method thereof.

An exemplary embodiment in the present disclosure may also provide a wireless communications system capable of improving system efficiency by traffic distribution upon selecting a frequency by dividing channel frequency information from a server into first channel frequency information for an initial connection and second channel frequency information for reconnection or frequency hopping and providing the divided information, and a method thereof.

An exemplary embodiment in the present disclosure may also provide a wireless communications system capable of reducing an access time in a multi-frequency environment by setting a network allocation vector for each frequency when requests to send (RTS) signals are received from a plurality of other terminals, and a method thereof.

According to an exemplary embodiment in the present disclosure, a wireless communications system may include: a server providing channel frequency information; an access point transmitting an enabling signal including the channel frequency information; and a terminal receiving the enabling signal to detect an unused channel, not currently in use through reference to the channel frequency information, transmitting a request to send (RTS) signal including a frequency number and duration of the unused channel upon detecting the unused channel, and setting the unused channel as a wireless communications channel upon receiving a clear to send (CTS) signal corresponding to the request to send (RTS) signal from the access point.

The channel frequency information may include: first channel frequency information including channel frequency information for an initial connection of the terminal; and second channel frequency information including channel frequency information for a reconnection of the terminal.

The terminal may detect the unused channel through reference to the second channel frequency information, when broadcasting traffic occurs in the unused channel performing the wireless communications.

The terminal may detect the unused channel through reference to the first channel frequency information and may re-detect the unused channel through reference to the second channel frequency information when the signal from the terminal collides with a signal from another terminal in the process of transmitting the request to send signal to secure access to the unused channel.

The terminal may set a network allocation vector based on a frequency number and duration which are included in the request to send (RTS) signal when the terminal receives the request to send a signal from another terminal.

The channel frequency information may include channel frequency information regarding TV white spaces (TVWS).

The channel frequency information may include at least one of maximum output power and available time information allowable for the frequency channel.

According to an exemplary embodiment in the present disclosure, a wireless communication method may include: receiving channel frequency information; detecting an unused channel, not currently in use through reference to the channel frequency information; transmitting a request to send (RTS) signal including a frequency number and duration of the unused channel when the unused channel is detected; receiving a clear to send (CTS) signal corresponding to the request to send (RTS) signal; and performing wireless communications using the unused channel.

The channel frequency information may include: first channel frequency information including channel frequency information for an initial connection of a terminal; and second channel frequency information including channel frequency information for a reconnection of the terminal.

The wireless communications method may further include, after the performing of the wireless communications, detecting the unused channel from the second channel frequency information, in the case that broadcasting traffic occurs in the unused channel.

In the detecting of the unused channel, the unused channel may be detected through reference to the first channel frequency information, and the unused channel may be re-detected through reference to the second channel frequency information when a signal from the terminal collides with a signal from another terminal in the process of transmitting a request to send signal to secure access to the unused channel.

The channel frequency information may include channel frequency information regarding TV white spaces (TVWS).

The channel frequency information may include at least one of maximum output power and available time information allowable for the frequency channel.

According to an exemplary embodiment in the present disclosure, a wireless communications terminal may include: a wireless communications unit receiving an enabling signal including channel frequency information from an access point; an unused channel detecting unit detecting an unused channel, not currently in use through reference to the channel frequency information; and a controlling unit transmitting a request to send (RTS) signal including a frequency number and duration of the unused channel through the wireless communications unit upon detecting the unused channel and setting the unused channel as a wireless communications channel upon receiving a clear to send (CTS) signal corresponding to the request to send (RTS) signal.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration diagram illustrating an example of a wireless communications system according to an exemplary embodiment of the present disclosure;

FIG. 2 is a configuration diagram illustrating an example of a terminal of FIG. 1;

FIG. 3 is a diagram illustrating an example of channel frequency information of the wireless communications system of FIG. 1;

FIG. 4 is a diagram illustrating an example of a request to send (RTS) signal and a clear to send (CTS) signal of the wireless communications system of FIG. 1;

FIG. 5 is a flow chart illustrating an example of a wireless communications method according to an exemplary embodiment of the present disclosure;

FIG. 6 is a flow chart illustrating another example of a wireless communications method according to an exemplary embodiment of the present disclosure; and

FIG. 7 is a flow chart illustrating another example of a wireless communications method according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

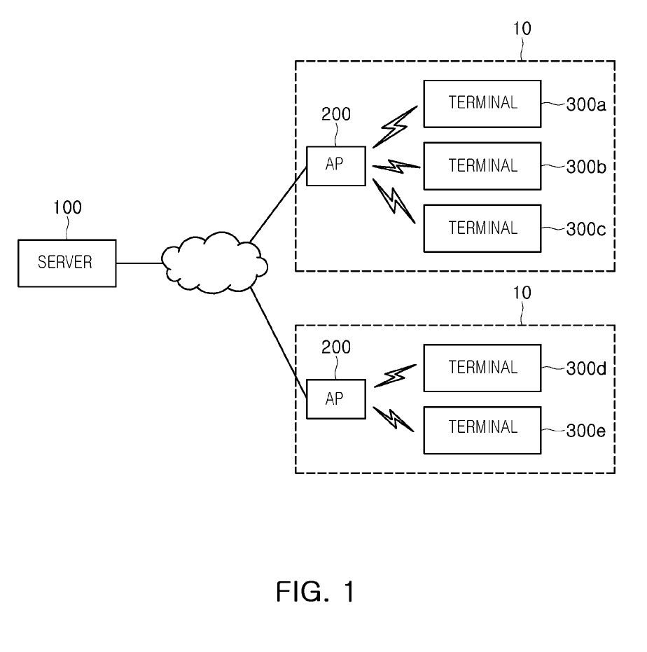

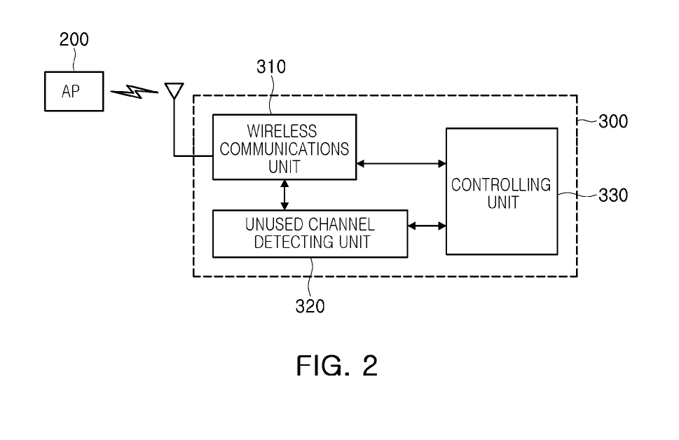

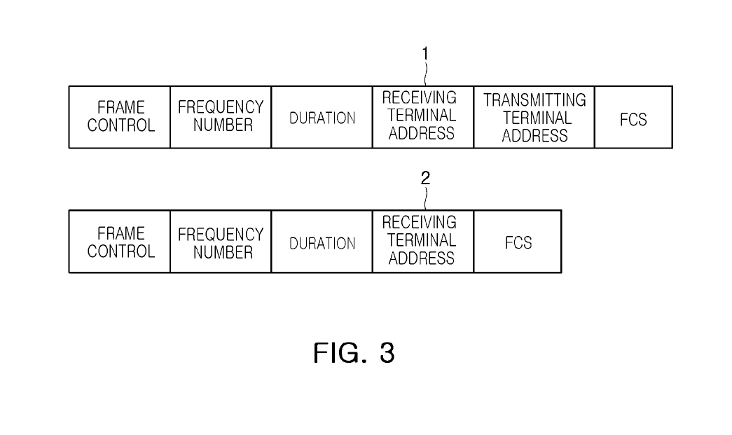

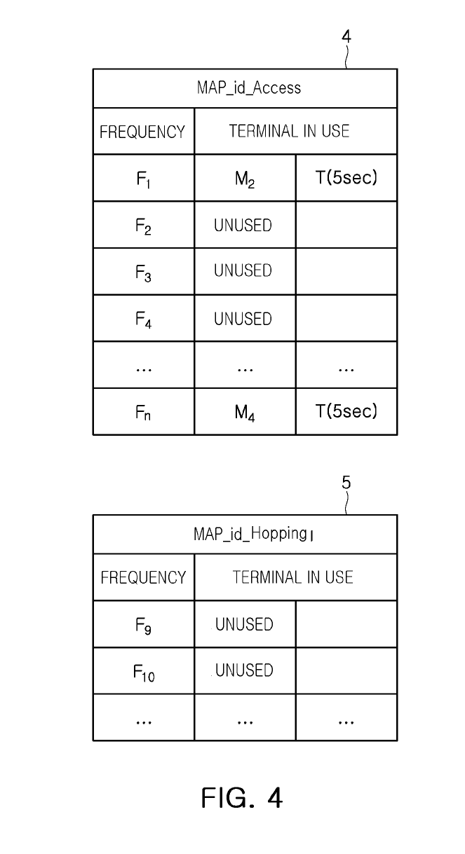

FIG. 1 is a configuration diagram illustrating an example of a wireless communications system according to an exemplary embodiment of the present disclosure, FIG. 2 is a configuration diagram illustrating an example of a terminal of FIG. 1, FIG. 3 is a diagram illustrating an example of channel frequency information of the wireless communications system of FIG. 1, and FIG. 4 is a diagram illustrating an example of a request to send (RTS) signal and a clear to send (CTS) signal of the wireless communications system of FIG. 1.

Referring to FIG. 1, the wireless communications system according to an exemplary embodiment of the present disclosure may include a server 100, access points (APs) 200, and terminals 300.

The server 100 may provide channel frequency information to the access point 200. Here, the channel frequency information may include information regarding frequency channels of TV white spaces (TVWS). In this case, the server 100 may be a geolocation database.

Here, the server 100 may be connected to the access point 200 through Internet communications and may provide available channel frequency information once the access point 200 provides its own location information.

In an example, the channel frequency information may include first channel frequency information 4, including channel frequency information for an initial connection, and second channel frequency information 5, for reconnection of the terminal 300, as illustrated in FIG. 2.

Here, the initial connection is referred to as a case in which the terminal 300 is initially connected to any frequency channel through the access point 200 to perform wireless communications in the case in which traffic is present, and the reconnection is referred to a case in which the terminal 300 channel-hops and is connected to another frequency channel in the case in which collision with a signal from another terminal occurs during an initial connection process or referred to a case in which a broadcasting traffic (an incumbent user (IU), for example, a broadcasting signal, a microphone signal, or the like) occurs in the frequency channel corresponding to the broadcasting in the process of performing the wireless communications.

For example, in the case in which the terminal 300 is initially connected or reconnected to a channel of any frequency to perform the wireless communications, the server 100 may divide the channel frequency information into the first channel frequency information and the second channel frequency information and provide the first channel frequency information and the second channel frequency information to the access point 200 so that the terminal 300 may be connected to the frequency channel through reference to different channel frequency information respectively corresponding to the initial connection and the reconnection.

As such, in the case in which the channel frequency information is provided by dividing the channel frequency information into the first channel frequency information for the initial connection and the second channel frequency information for the reconnection, the possibility that data from the terminal 300 performing the reconnection will collide with data from another terminal 300 may be reduced.

The access point 200 may receive the channel frequency information from the server 100, and generate and broadcast an enabling signal including the channel frequency information. The access point 200 may be connected to the server 100 through Internet communications and may be connected to at least one terminal 300 through wireless communications.

Here, one access point 200 may be connected to one or more terminals 300a, 300b, and 300c to thereby configure a basic service set (BSS) 10.

In an example, the access point 200 may calculate its own location information. The access point 200 may transmit a query request including the calculated location information and a terminal type (e.g., stationary or mobile) to the server 100 and may receive the channel frequency information from the server 100 receiving the query request.

Here, the channel frequency information may include at least one of maximum output power allowable for and an available time allowable for a respective frequency channel.

The terminal 300 may receive a wireless communications service under a control of the access point 200. The terminal 300 may first receive the enabling signal from the access point 200.

The terminal 300 may detect an unused channel, not currently in use, through reference to the channel frequency information included in the received enabling signal, once the traffic occurs. In the case in which the unused channel is detected, the terminal 300 may broadcast a request to send (RTS) signal 1 including a frequency number and duration of the unused channel.

Here, the request to send (RTS) signal 1 may include the frequency number and the duration, as illustrated in FIG. 3. The request to send (RTS) signal 1 transmitted by any one terminal 300a within the BSS 10 may be received by the access point 200 within the BSS 10, as well as by other terminals 300b and 300c, and here, the access point 200 receiving the request to send (RTS) signal 1 may transmit a clear to send (CTS) signal 2 corresponding to the request to send (RTS) signal 1.

Other terminals 300b and 300c may set a network allocation vector (NAV) with reference to the frequency number and the duration of the received request to send (RTS) signal 1.

For example, other terminals 300b and 300c receiving the request to send (RTS) signal 1 may wait in a sleep state at minimum power by setting the network allocation vector (NAV) in order to avoid an access to the frequency number used by the terminal 300a outputting the request to send (RTS) signal 1 during the duration.

In an example, in the case in which any one terminal 300c within the BSS 10 receives the request to send (RTS) signal 1 from the plurality of terminals 300a and 300b, respectively, the terminal 300c may set the network allocation vector for each frequency number.

For example, in the case in which any one terminal 300c receives a first request to send having content in which it uses a first frequency f1 for five seconds from the first terminal 300a and receives a second request to send having content in which it uses a second frequency f2 for ten seconds from the second terminal 300b, the terminal 300c may set a first network allocation vector for five seconds for the first frequency f1 and may set a second network allocation vector for ten seconds for the second frequency f2.

As such, the present disclosure may reduce a collision rate between signals from the terminals 300 by setting the network allocation vector for each frequency number in the wireless communications system having the plurality of frequency channels.

When the terminal 300 receives the clear to send (CTS) signal 2 corresponding to the request to send (RTS) signal 1 from the access point 200, it may perform the wireless communications on the frequency channel.

Here, when the plurality of terminals 300 output the request to send (RTS) signal 1 to one frequency channel, the collision may occur between signals from the plurality of terminals 300.

In this case, the plurality of terminals 300 having the collision that has occurred therebetween may detect a new unused frequency channel and may broadcast a request to send (RTS) signal including a frequency number and duration of the detected unused frequency channel.

In an example, the terminal 300 may detect another frequency channel according to a priority of quality of service (QoS) preset to thereby determine whether or not it is reconnected to the detected frequency channel, when the collision between signals from the terminals 300 occurs.

For example, in the case in which signals from the first terminal 300a and the second terminal 300b collide with each other on the first frequency f1, when quality of service (QoS) of the first terminal 300a has a first priority and quality of service (QoS) of the second terminal 300b has a second priority, the first terminal 300a may again output the request to send (RTS) signal for the first frequency f1 to be reconnected to the first frequency f1 and the second terminal 300b may detect another unused frequency channel to be reconnected thereto. Here, the second terminal 300b may detect the unused channel through reference to the second channel frequency information 5.

In an example, the terminal 300 may include a wireless communications unit 310, an unused channel detecting unit 320, and a controlling unit 330, as illustrated in FIG. 2.

The wireless communications unit 310 may receive the enabling signal or the clear to send (CTS) signal from the access point 200 or other terminals and may broadcast the request to send (RST).

The unused channel detecting unit 320 may detect an unused channel not currently in use through reference to the channel frequency information included in the enabling signal.

Here, the unused channel detecting unit 320 may detect the unused channel from the first channel frequency information in a case of the initial connection, and may detect the unused frequency channel from the second channel frequency information in a case of the reconnection caused by the collision or the occurrence of the broadcasting traffic.

The controlling unit 330 may broadcast a request to send (RTS) signal including a frequency number and duration of the unused channel through the wireless communications unit 310 when the unused channel is detected by the unused channel detecting unit 320, and may set the unused channel as a wireless communications channel when the controlling unit 330 receives a clear to send (CTS) signal corresponding to the request to send (RST) from the access point 200 through the wireless communications unit 310.

In addition, when the controlling unit 330 receives the request to send (RTS) signal from other terminal through the wireless communications unit 310, the controlling unit 330 may set the network allocation vector based on the frequency number and the duration which are included in the request to send (RTS) signal.

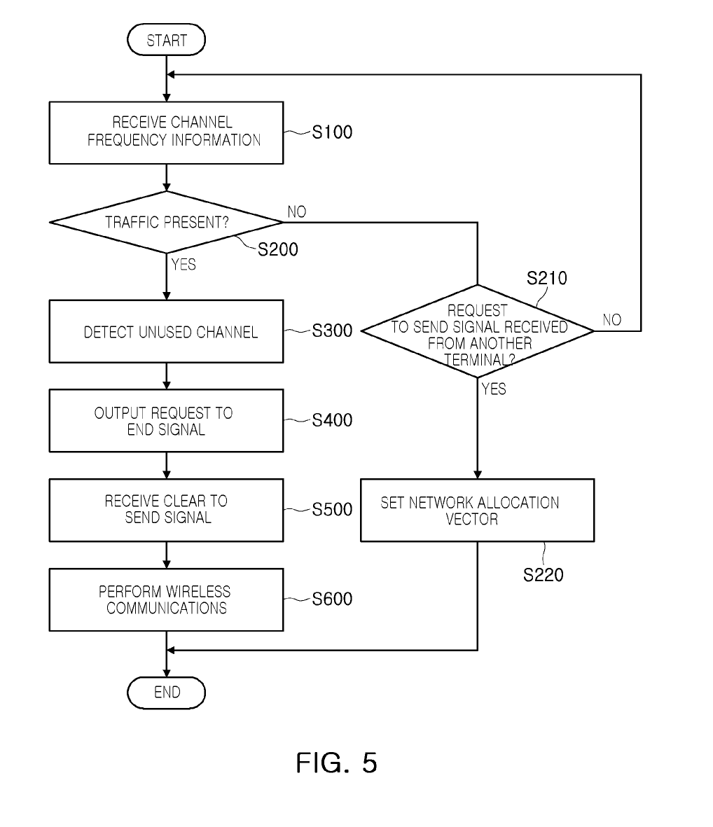

FIG. 5 is a flow chart illustrating an example of a wireless communications method according to an exemplary embodiment of the present disclosure.

Since an example of the wireless communications method illustrated in FIG. 5 is performed in the wireless communications system described above with reference to FIGS. 1 through 4, overlapped descriptions of contents the same as or corresponding to the above-mentioned contents with reference to FIGS. 1 to 4 will be omitted.

Referring to FIG. 5, in the wireless communications method according to an exemplary embodiment of the present disclosure, first, the terminal 300a may receive, through the access point 200, the channel frequency information received from the server 100 (S100). Here, the channel frequency information may be included in the enabling signal output from the access point 200.

Next, when the traffic occurs (S200), the terminal 300a may detect the unused channel through reference to the channel frequency information (S300). When the unused channel is detected by the terminal 300a, the terminal 300a may broadcast the request to send (RTS) signal (S400).

Here, the request to send (RTS) signal may include the frequency number and the duration of the unused channel and may be transmitted to the access point 200 or other terminals 300b and 300c within the BSS 10.

In an example, the wireless communications method may further include a back-off operation of waiting for a random time value between the operation of outputting the request to send (RTS) signal (S400) and the operation of detecting the unused channel (S300).

In another example, the wireless communications method may include receiving an enabling signal including the channel frequency information from the access point 200 when the traffic occurs.

For example, the terminal 300a may detect the unused channel through reference to the channel frequency information provided prior to the occurrence of the traffic or may detect the unused channel by receiving the channel frequency information according to the request after the occurrence of the traffic.

Next, when the terminal 300a receives the clear to send (CTS) signal from the access point 200 (S500), the terminal 300a may perform the wireless communications on the frequency channel (S600).

In an example, when the terminal 300a receives the request to send (RTS) signal from the other terminals 300b and 300c (S210), the terminal 300a may set the network allocation vector for a respective frequency number with reference to the frequency number and the duration which are included in the request to send signal (S220).

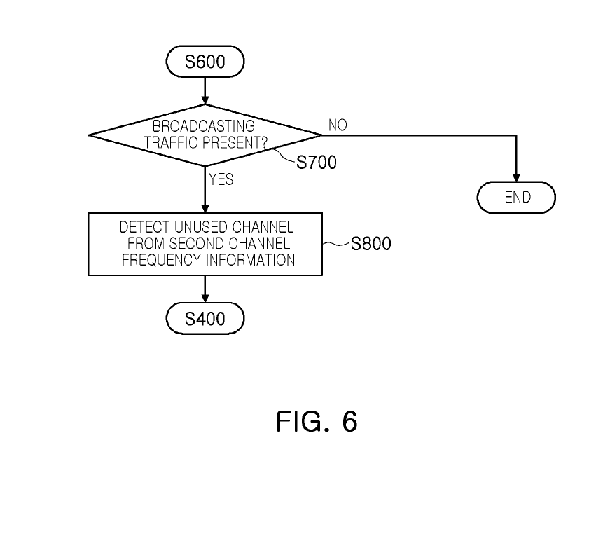

FIG. 6 is a flow chart illustrating another example of a wireless communications method according to an exemplary embodiment of the present disclosure.

Referring to FIG. 6, in the wireless communications method according to another exemplary embodiment of the present disclosure, when the broadcasting traffic (IU) occurs in the frequency channel performing the wireless communications (S700) during the operation of performing the wireless communications (S600), the terminal 300 may terminate the wireless communications and may be reconnected to another frequency channel to perform the wireless communications. This is referred to as frequency hopping. To this end, the terminal 300 may terminate the wireless communications and may detect the unused channel from the second channel frequency information (S800).

Next, when the terminal 300 detects the unused channel, the terminal 300 may broadcast the request to send (RTS) signal (S400), and when the terminal 300 receives the clear to send (CTS) signal corresponding to the request to send (RTS) signal (S500), the terminal 300 may again perform the wireless communications on the frequency of the unused channel (S600).

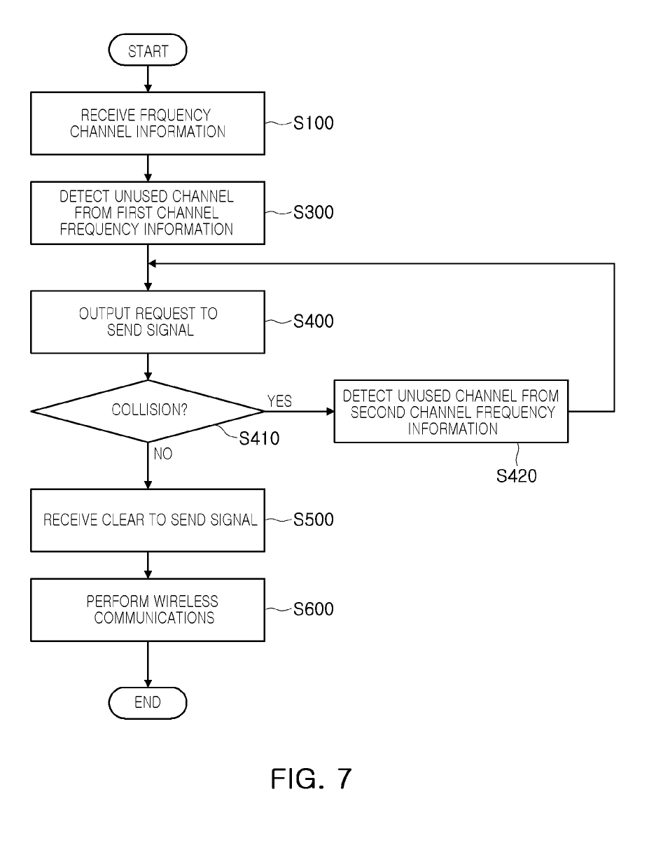

FIG. 7 is a flow chart illustrating another example of a wireless communications method according to an exemplary embodiment of the present disclosure.

Referring to FIG. 7, first, the terminal 300a may receive the channel frequency information including the first channel frequency information and the second channel frequency information from the access point 200 (S100).

Next, the terminal 300a may detect the unused channel through reference to the first channel frequency information (S300). When the terminal 300a detects the unused channel, the terminal 300a may broadcast the request to send (RTS) signal including the frequency number and the duration of the unused channel (S400).

In this case, when the signal from the terminal 300a collides with a signal from another terminal 300b in the unused channel (S410), the terminal 300a may detect the unused channel from the second channel frequency information (S420).

When the terminal 300a outputs the request to send (RTS) signal including the frequency number and the duration of the detected unused channel and receives the clear to send (CTS) signal corresponding to the request to send (RST) signal (S500), the terminal 300a may perform the wireless communications on the frequency channel (S600).

According to exemplary embodiments of the present disclosure, the terminal outputs the request to send (RTS) signal including the frequency number and the duration to thereby cause another terminal to select and access another frequency channel, whereby the collision may be prevented.

In addition, the system efficiency may be improved by traffic dispersion upon selecting the frequency by dividing the channel frequency information provided from the server into the first channel frequency information for the initial connection and the second channel frequency information for the reconnection or frequency hopping and providing the divided channel frequency information.

In addition, the access time in a multi frequency environment may be reduced by setting a network allocation vector for a respective frequency when the request to send (RTS) signals are received from the plurality of other terminals.

While exemplary embodiments have been shown and described above, it will be apparent to those skilled in the art that modifications and variations could be made without departing from the spirit and scope of the present disclosure as defined by the appended claims.

What is claimed is:

1. A wireless communications system comprising:
a server configured to provide channel frequency information;
an access point configured to transmit an enabling signal including the channel frequency information; and
a terminal configured to receive the enabling signal to detect an unused channel not currently in use through reference to the channel frequency information, transmitting a request to send (RTS) signal including a frequency number and duration of the unused channel upon detecting the unused channel, and setting the unused channel as a wireless communications channel upon receiving a clear to send (CTS) signal corresponding to the request to send (RTS) signal from the access point.

2. The wireless communications system of claim 1,
wherein the channel frequency information comprises:
first channel frequency information including channel frequency information for an initial connection of the terminal; and
second channel frequency information including channel frequency information for a reconnection of the terminal.

3. The wireless communications system of claim 2, wherein the terminal detects the unused channel through reference to the second channel frequency information, in the case that broadcasting traffic occurs in the unused channel performing the wireless communications.

4. The wireless communications system of claim 2, wherein the terminal detects the unused channel through reference to the first channel frequency information and re-detects the unused channel through reference to the second channel frequency information when the signal from the terminal collides with a signal from another terminal in the process of transmitting the request to send signal to secure access to the unused channel.

5. The wireless communications system of claim 1, wherein the terminal sets a network allocation vector based on a frequency number and duration which are included in the request to send (RTS) signal when the terminal receives the request to send a signal from another terminal.

6. The wireless communications system of claim 1, wherein the channel frequency information includes channel frequency information regarding TV white spaces (TVWS).

7. The wireless communications system of claim 1, wherein the channel frequency information includes at least one of maximum output power and available time information allowable for the frequency channel.

8. A wireless communication method comprising:
receiving channel frequency information;
detecting an unused channel not currently in use through reference to the channel frequency information;
transmitting a request to send (RTS) signal including a frequency number and duration of the unused channel when the unused channel is detected;
receiving a clear to send signal corresponding to the request to send signal; and
performing wireless communications using the unused channel.

9. The wireless communications method of claim 8, wherein the channel frequency information comprises:
first channel frequency information including channel frequency information for an initial connection of a terminal; and
second channel frequency information including channel frequency information for a reconnection of the terminal.

10. The wireless communications method of claim 9, further comprising, after the performing of the wireless communications, detecting the unused channel from the second channel frequency information, when broadcasting traffic occurs in the unused channel.

11. The wireless communications method of claim 9, wherein in the detecting of the unused channel, the unused channel is detected through reference to the first channel frequency information, and the unused channel is re-detected through reference to the second channel frequency information when a signal from the terminal collides with a signal from another terminal in the process of transmitting a request to send signal to secure access to the unused channel.

12. The wireless communications method of claim 8, wherein the channel frequency information includes channel frequency information regarding TV white spaces (TVWS).

13. The wireless communications method of claim 8, wherein the channel frequency information includes at least one of maximum output power and available time information allowable for the frequency channel.

14. A wireless communications terminal comprising:
a wireless communications unit configured to receive an enabling signal including channel frequency information from an access point;
an unused channel configured to detect unit detecting an unused channel not currently in use through reference to the channel frequency information; and
a controlling unit configured to transmit a request to send (RTS) signal including a frequency number and duration of the unused channel through the wireless communications unit upon detecting the unused channel and setting the unused channel as a wireless communications channel upon receiving a clear to send (CTS) signal corresponding to the request to send (RTS) signal.

15. The wireless communications terminal of claim 14, wherein the channel frequency information comprises:
first channel frequency information including channel frequency information for an initial connection of the terminal; and
second channel frequency information including channel frequency information for a reconnection of the terminal.

16. The wireless communications terminal of claim 15, wherein the unused channel detecting unit detects the unused channel through reference to the second channel frequency information, in the case that broadcasting traffic occurs in the unused channel performing the wireless communications.

17. The wireless communications terminal of claim 15, wherein the unused channel detecting unit detects the unused channel through reference to the first channel frequency information and re-detects the unused channel through reference to the second channel frequency information when the signal from the terminal collides with a signal from another terminal in the process of transmitting the request to send signal to secure access to the unused channel.

18. The wireless communications terminal of claim 14, wherein the terminal sets a network allocation vector based on a frequency number and duration which are included in the request to send (RTS) signal when the terminal receives the request to send signal from another terminal.

19. The wireless communications terminal of claim 14, wherein the channel frequency information includes channel frequency information regarding TV white spaces (TVWS).

20. The wireless communications terminal of claim 14, wherein the channel frequency information includes at least one of maximum output power and available time information allowable for the frequency channel.
